(19) United States
(12) Patent Application Publication
(10) Pub. No.: US 2026/0017389 A1
(43) Pub. Date: Jan. 15, 2026

(54) SYSTEMS AND METHODS FOR ROLE-BASED ACCESS CONTROL (RBAC) USING LARGE LANGUAGE MODEL (LLM) EMBEDDINGS

(71) Applicant: Dell Products L.P., Round Rock, TX (US)

(72) Inventor: Shibi Panikkar, Bangalore (IN)

(73) Assignee: Dell Products L.P., Round Rock, TX (US)

(21) Appl. No.: 18/771,803

(22) Filed: Jul. 12, 2024

(51) Int. Cl. G06F 21/60

(52) U.S. Cl. CPC G06F 21/604; G06F 2221/2113; G06F 2221/2141

(57) ABSTRACT

Systems and methods for Role-Based Access Control (RBAC) using Large Language Model (LLM) embeddings are described. In an illustrative, non-limiting embodiment, an Information Handling System (IHS) may include a processor and a memory coupled to the processor. The memory may store program instructions that, upon execution, generate a plurality of distinct unstructured natural language documents from a same portion of structured data of an enterprise, with each document created for a corresponding role in the enterprise. The IHS may concatenate a role context vector that defines an access privilege for a document with a document vector associated with the document to produce a role-integrated document vector. The IHS may also apply pre-attention and post-attention layers to the role context vector to manage access control during document retrieval based on user roles.

### FIELD

This disclosure relates generally to Information Handling Systems (IHSs), and more specifically, to systems and methods for Role-Based Access Control (RBAC) using Large Language Model (LLM) embeddings.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Systems and methods for Role-Based Access Control (RBAC) using Large Language Model (LLM) embeddings are described. In an illustrative, non-limiting embodiment, an Information Handling System (IHS) may include a processor and a memory coupled to the processor, the memory having program instructions stored thereon that, upon execution, cause the IHS to generate a plurality of distinct unstructured natural language documents from a same portion of structured data of an enterprise, where each document is created for a corresponding role in the enterprise; and concatenate a role context vector that defines an access privilege for a document with a document vector associated with the document to produce a role-integrated document vector.

In some cases, the IHS may generate the plurality of distinct unstructured natural language documents by selecting a differentiating entity; and adding selected ones of a plurality of data items to different Natural Language templates based, at least in part, upon the differentiating entity. For example, the differentiating entity may include a customer identifier.

The IHS may generate the plurality of distinct unstructured natural language documents by associating each of a plurality of data items with a respective context indicator; and add the selected ones of the plurality of data items to the different Natural Language templates based, at least in part, upon the context indicators. The context indicators may include at least one of: human resources, financial information, Information Technology (IT), customer service, sales data, marketing analytics, product details, legal documents, compliance records, supply chain information, project management data, research and development reports, inventory levels, procurement details, or executive summaries.

The IHS may produce the role-integrated document vector by creating role-specific tokens based, at least in part, upon role data retrieved from an Identity and Access Management (IAM) database; and assembling the role-specific tokens into the role context vector. The IHS may apply a pre-attention layer's attention to the role context vector, and the pre-attention layer may be configured to exclude the document from an LLM search if a user's role does not match a role specified in the role-integrated document vector. Additionally, or alternatively, the IHS may apply a post-attention layer's attention to the role context vector, and the post-attention layer may be configured to determine whether a user's context matches a context specified in the role-integrated document vector.

The IHS may vectorize a query received by a LLM from a user; and retrieve one or more of the documents as part of a similarity search to fulfill the query based, at least in part, upon a comparison between the vectorized query and the role-integrated document vectors for each of the one or more documents.

In another illustrative, non-limiting embodiment, a method may include generating a plurality of distinct unstructured natural language documents from a same portion of structured data of an enterprise, where each document is created for a corresponding role in the enterprise, and where the document is associated with one or more context indicators; and integrating a role context vector that defines an access privilege for a document with a document vector associated with the document to produce a role-integrated document vector.

In some cases, generating the plurality of distinct unstructured natural language documents may include selecting a differentiating entity; and adding selected ones of a plurality of data items to different Natural Language templates based, at least in part, upon the differentiating entity. The differentiating entity may include a customer identifier and the one or more context indicators comprise at least one of: human resources, financial information, Information Technology (IT), customer service, sales data, marketing analytics, product details, legal documents, compliance records, supply chain information, project management data, research and development reports, inventory levels, procurement details, or executive summaries.

Moreover, producing the role-integrated document vector may include assembling role-specific tokens into the role context vector; and concatenating the role context vector with the document vector. The method may also include vectorizing a query received by a Large Language Model (LLM) from a user; and retrieving one or more of the documents as part of a similarity search to fulfill the query based, at least in part, upon a comparison between the vectorized query and the role-integrated document vectors for each of the one or more documents.

In yet another illustrative, non-limiting embodiment, a hardware memory device may have program instructions stored thereon that, upon execution by a processor of an IHS, cause the IHS to generate a plurality of distinct unstructured natural language documents from a same portion of structured data of an enterprise, where each document is created for a corresponding role in the enterprise, and where the document is associated with one or more context indicators; and integrate a role context vector that defines an access privilege for a document with a document vector associated with the document to produce a role-integrated document vector.

The IHS may generate the plurality of distinct unstructured natural language documents by associating each of a plurality of data items with a respective context indicator; and add the selected ones of the plurality of data items to the different Natural Language templates based, at least in part, upon the context indicators.

The IHS may produce the role-integrated document vector by applying a pre-attention layer's attention to the role context vector, where the pre-attention layer is configured to exclude the document from an LLM search if a user's role does not match a role specified in the role-integrated document vector; and applying a post-attention layer's attention to the role context vector, where the post-attention layer is configured to determine whether a user's context matches a context specified in the role-integrated document vector.

In some implementations, the processor may be part of a heterogenous computing platform selected from the group consisting of: a System-On-Chip (SoC), a Field-Programmable Gate Array (FPGA), and an Application-Specific Integrated Circuit (ASIC). According to another aspect, the heterogenous computing platform comprises a Reduced Instruction Set Computer (RISC) processor coupled to an Embedded Controller (EC) via an interconnect, and where the interconnect comprises at least one of: an Advanced Microcontroller Bus Architecture (AMBA) bus, a QuickPath Interconnect (QPI) bus, or a HyperTransport (HT) bus.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS), according to some embodiments.

FIG. 2 is a diagram illustrating an example of a heterogenous computing platform, according to some embodiments.

FIG. 3 is a diagram illustrating an example of a software and firmware architecture of an IHS, according to some embodiments.

FIG. 4 is a diagram illustrating an example of a Role-Based Retrieval Augmented Generation (RBRAG) system for Role-Based Access Control (RBAC) using Large Language Model (LLM) embeddings, according to some embodiments.

FIG. 5 is a diagram illustrating an example of a method for Role-Based Access Control (RBAC) using Large Language Model (LLM) embeddings, according to some embodiments.

FIG. 6 is a diagram illustrating examples of role-integrated document vectors analyzed during a role-aware similarly data search operation, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various Input/Output (I/O) devices, such as a keyboard, a mouse, touchscreen, and/or a video display. An IHS may also include one or more buses operable to transmit communications between the various hardware components.

The terms “heterogenous computing platform,” “heterogenous processor,” or “heterogenous platform,” as used herein, refer to an Integrated Circuit (IC) or chip (e.g., a System-On-Chip or “SoC,” a Field-Programmable Gate Array or “FPGA,” an Application-Specific Integrated Circuit or “ASIC,” etc.) containing a plurality of discrete processing circuits or semiconductor Intellectual Property (IP) cores (collectively referred to as “SoC devices” or simply “devices”) in a single electronic or semiconductor package, where each device has different processing capabilities suitable for handling a specific type of computational task. Examples of heterogenous processors include, but are not limited to: QUALCOMM's SNAPDRAGON, SAMSUNG's EXYNOS, APPLE's “A” SERIES, etc., which typically include ARM core(s).

In the field of enterprise data management, the advent of Large Language Models (LLMs) has revolutionized the way organizations process and retrieve information. In this context, the term “embeddings” or “LLM embeddings” refers to vectorized representations of textual data generated by LLMs.

An embedding transforms text into numerical vectors that capture the semantic meaning of the text. This transformation allows for the representation of words, phrases, or entire documents in a continuous vector space, where semantically similar items are positioned closer together.

In similarity searches, embeddings enable the comparison of these vectors to identify and retrieve text that is contextually or semantically like a given query. This may be achieved through mathematical operations, such as cosine similarity, which measures the angle between vectors to determine their likeness. As a result, embeddings can quickly and accurately find relevant information within large datasets, significantly improving search efficiency.

For NLP tasks, embeddings may provide a representation of text that captures nuanced relationships between words and their contexts. This allows LLMs to perform various NLP tasks more effectively, such as sentiment analysis, machine translation, text summarization, and question-answering. By leveraging embeddings, LLMs can understand and generate human-like text, enhancing their ability to process and interpret natural language.

The term “natural language,” as used herein, refers to human language, which is used for everyday communication and is characterized by its complexity, variability, and ambiguity. Natural language documents are written in human language, making them easily understandable.

In data management, structured data and unstructured data serve unique purposes within an enterprise. Structured data is typically highly organized and easily searchable in predefined formats, typically stored in databases or spreadsheets. This type of data may be often managed using Online Transaction Processing (OLTP) systems, which handle many short online transactions, and Online Analytical Processing (OLAP) systems, which enable complex queries and analysis. Examples of structured data include customer records, transaction logs, and inventory lists.

Unstructured data, in contrast, generally lacks a predefined format or organization, often making it more challenging to store, search, and analyze. This type of data is often found in natural language documents. Examples of unstructured data include emails, social media posts, and text documents.

In some cases, data processing techniques such as Natural Language Processing (NLP) and machine learning may be employed to extract meaningful information from unstructured data, facilitating tasks such as sentiment analysis, text summarization, and information retrieval.

In this context, Retrieval-Augmented Generation (RAG) is a technique used by enterprise LLMs to enhance the generation of natural language responses by incorporating relevant information retrieved from external sources. With RAG, a model first retrieves relevant documents or data from a knowledge base or database and then uses this retrieved information to generate a more accurate and contextually appropriate response.

As such, RAG combines the strengths of retrieval-based methods, which can access and utilize a vast amount of external information, with the generative capabilities of LLMs, which can produce coherent and contextually relevant text. This approach is particularly useful in scenarios where the model needs to provide detailed and specific information that may not be fully captured within the training data of the LLM alone.

However, traditional Role-Based Access Control (RBAC) mechanisms are not designed to handle the unstructured and vectorized nature of data in LLM embeddings. Consequently, enterprises face difficulties in implementing role-based access controls for embeddings, leading to potential data breaches and unauthorized access to sensitive information.

That is in part because conventional forms of LLM embeddings are limited when handling sensitive information such as subscription details, billing information, and licensing information. For instance, in a typical enterprise setting, various departments such as IT, finance, and license management have distinct access requirements. In some cases, it may not be desirable for an IT user to have access to billing information or order values, or for the finance team to have access to licensing information. In contrast, a CEO should have access to all types of information.

To address these, and other concerns, systems and methods described herein provide RBAC-Aware vectorization and embedding retrieval mechanisms. These mechanisms may prioritize role context during the vectorization process, ensuring that the generated embeddings are aware of user roles. By integrating role tokens with document vectors through attention layers, these systems and methods may enable precise control over data access, allowing only authorized users to retrieve relevant information. This approach may enhance data security and ensure compliance with organizational data governance policies.

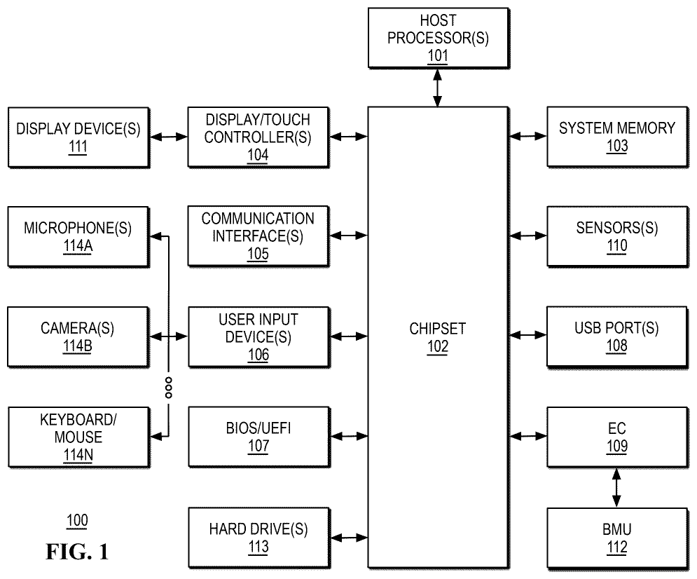

To illustrate this, FIG. 1 is a block diagram of examples of components of IHS 100, according to some embodiments. As shown, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless networks, such as ETHERNET, WIFI, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, headsets, etc.). Moreover, communication interface(s) 105 may be coupled to chipset 102 via a Peripheral Component Interconnect Express (PCIe) bus, or the like. Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 may provide video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may operate as a single continuous display, rather than two discrete displays.

Chipset 102 may provide host processor(s) 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more USB ports 108, to which one or more peripheral devices may be coupled (e.g., integrated or external webcams, microphones, speakers, etc.). Chipset 102 may further provide host processor(s) 101 with access to one or more hard disk drives, solid-state drives, optical drives, or other removable media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc.

Each user input device 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality or “VR/AR” devices, etc.).

In certain embodiments, chipset 102 may further provide an interface for communications with one or more hardware sensors 110. Sensor(s) 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), accelerometer, etc.

Basic Input/Output System (BIOS)/Unified Extensible Firmware Interface (UEFI) 107 is coupled to chipset 102. In some situations, the terms “BIOS” and “UEFI” may be used interchangeably. In operation, BIOS/UEFI 107 provides an abstraction layer that allows a host OS to interface with certain hardware components utilized by IHS 100.

When IHS 100 is powered on, host processor(s) 101 may utilize program instructions of BIOS/UEFI 107 to initialize and test hardware components coupled to IHS 100, and to load host OS 312 for use by IHS 100. As used herein, the term “pre-boot” refers to the period of time, processes, and/or environment between the initialization of host processor(s) 101 and its taking over by host OS 312, after host OS 312 is loaded and operational.

Through a hardware abstraction layer provided by BIOS/UEFI 107, software stored in system memory 103 and executed by host processor(s) 101 may interface with certain I/O devices that are coupled to IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as operating chassis buttons and/or switches (e.g., power button, laptop lid switch, etc.), receiving and processing thermal measurements (e.g., performing cooling fan control, CPU and GPU throttling, and emergency shutdown), controlling indicator Light-Emitting Diodes or “LEDs” (e.g., caps lock, scroll lock, num lock, battery, ac, power, wireless LAN, sleep, etc.), managing a battery charger and a battery, enabling remote management, diagnostic tests (or “diagnostics”), remediation over an OOB or sideband network, etc.

Unlike other devices in IHS 100, EC 109 may be operational from the time IHS 100 is first powered on, before other devices are fully running or even powered. As such, EC 109 firmware may be responsible for interfacing with a power adapter to manage the various power states that may be supported by IHS 100. Power operations of the EC 109 may also provide other components of the IHS 100 with power status information for the IHS, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.).

From the perspective of users, IHS 100 may appear to be either “on” or “off,” without any other detectable power states. In some embodiments, however, an IHS 100 may support multiple power states that may correspond to the states defined in the Advanced Configuration and Power Interface (ACPI) specification, such as: S0, S1, S2, S3, S4, S5, and G3.

EC 109 may implement operations for detecting certain changes to the physical configuration or posture of IHS 100 (such as a laptop computer). For instance, when IHS 100 as a 2-in-1 laptop/tablet form factor, EC 109 may receive inputs from a lid position or hinge angle sensor 110, and may use those inputs to determine: whether the two sides of IHS 100 have been latched together to a closed position or a tablet position, the magnitude of a hinge or lid angle, etc. In response to these changes, EC 109 may enable or disable certain features of IHS 100 (e.g., front or rear facing camera, etc.).

In this manner, EC 109 may identify any number of IHS physical postures, including, but not limited to: laptop, stand, tablet, or book. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user.

In some implementations, EC 109 may be installed as part of a Trusted Execution Environment (TEE) component to the motherboard of IHS 100. As a component with hardware root-of-trust (ROT), EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC 109 may later recalculate a hash value based on instructions and settings loaded for use by a hardware component of IHS 100 and may compare the calculated value against the reference hash value to determine if any modifications have been made to the component, thus indicating that the component has been compromised. As such, EC 109 may validate the integrity of hardware and software components installed in IHS 100.

In some embodiments, EC 109 may provide an OOB (Out-Of-Band) or sideband channel that allows an Information Technology Decision Maker (ITDM) or Original Equipment Manufacturer (OEM) to manage various settings and configurations of an IHS 100. OOB is used in contradistinction with “in-band” communication channels that operate only after networking 105 other interfaces of the IHS have been initialized, and the OS of the IHS has been successfully booted.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 112 may be coupled to EC 109 and it may include, for example, an Analog Front End (AFE), storage (e.g., non-volatile memory), and a microcontroller. In some cases, BMU 112 may be configured to collect and store information, and to provide that information to EC 109.

Examples of information collectible by BMU 112 may include, but are not limited to: operating conditions (e.g., battery operating conditions including battery state information such as battery current amplitude and/or current direction, battery voltage, battery charge cycles, battery state of charge, battery state of health, temperature, battery usage data such as charging and discharging data; and/or IHS operating conditions such as processor operating speed data, system power management and cooling system settings, state of “system present” pin signal), environmental or context information (e.g., such as ambient temperature, relative humidity, system geolocation measured by GPS or triangulation, time and date, etc.), etc.

In various embodiments, EC 109 may be coupled (e.g., via a GPIO pin) to any of a plurality of IHS components including, but not limited to: a fan, a cable, a battery, a temperature sensor, or a display. Moreover, EC 109 may be configured to perform or trigger the performance of any number of diagnostic operations for any of these components. For example, in some cases EC 109 may be configured to request that display 111 perform a Built-In-Self-Test (BIST) and to return BIST results to EC 109 upon completion. In other cases, however, EC 109 may itself run the diagnostic operation.

In some embodiments, IHS 100 may not include all components shown in FIG. 1. In other embodiments, IHS 100 may include other components in addition to those shown in FIG. 1. Furthermore, some components illustrated as separate components in FIG. 1 may instead be integrated with other components, such that all or a portion of the operations executed by the illustrated components may instead be executed by the integrated component.

For instance, in various embodiments, host processor(s) 101 and/or other components shown in FIG. 1 (e.g., chipset 102, display controller(s) 104, communication interface(s) 105, EC 109, etc.) may be replaced by devices within a heterogenous computing platform. As such, IHS 100 may assume different form factors including, but not limited to: servers, workstations, desktops, laptops, appliances, video game consoles, tablets, smartphones, etc.

Historically, IHSs with desktop and laptop form factors have had conventional host OSs executed on INTEL or AMD's “x86”-type processors. Other types of processors, such as ARM processors, have been used in smartphones and tablet devices, which typically run thinner, simpler, and/or mobile OSs (e.g., ANDROID, IOS, WINDOWS MOBILE, etc.). More recently, however, IHS manufacturers have started producing fully-fledged desktop and laptop IHSs equipped with ARM-based, heterogenous computing platforms. Accordingly, host OSs (e.g., WINDOWS on ARM) have been developed to provide users with a familiar OS experience on those platforms.

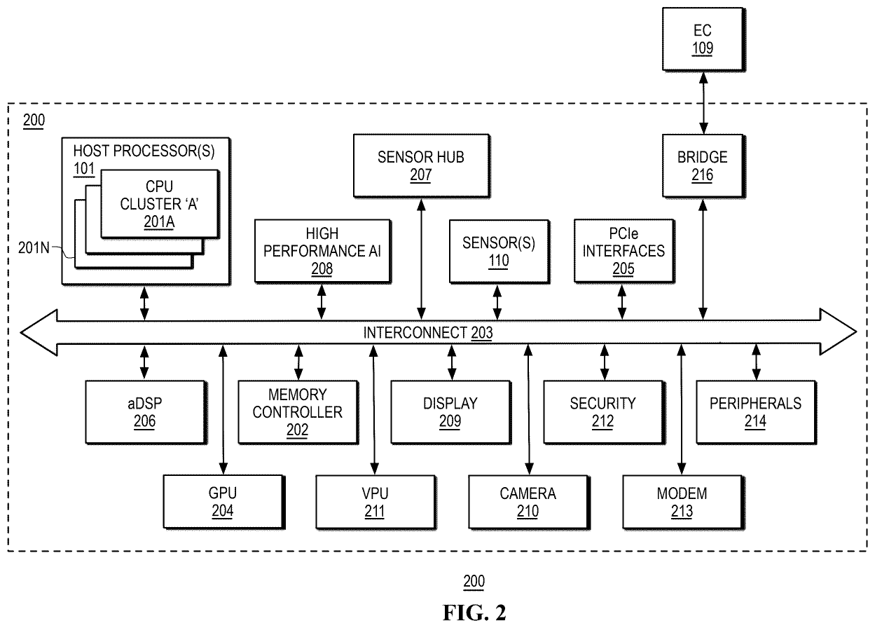

FIG. 2 is a diagram illustrating an example of heterogenous computing platform 200 which may be implemented as part of IHS 100 and/or it may replace certain components shown in FIG. 1 (e.g., host processor(s) 101)). In various embodiments, heterogenous computing platform 200 may be implemented as one or more SoCs, FPGAS, ASICs, or the like.

Heterogenous computing platform 200 may include one or more discrete and/or segregated devices or components, each having a different set of processing capabilities suitable for handling a particular type of computational task. When each device in platform 200 is tasked with executing only the types of computational tasks that it is specifically designed to execute, the overall power consumption of heterogenous computing platform 200 is reduced.

In various implementations, some of the devices in heterogenous computing platform 200 may include their own microcontroller(s) or core(s) (e.g., ARM core(s)) and corresponding firmware. In some cases, a device in platform 200 may also include its own hardware-embedded accelerator (e.g., a secondary or co-processing core coupled to a main core). Each device in heterogenous computing platform 200 may be accessible through a respective Application Programming Interface (API). Additionally, or alternatively, some devices in heterogenous computing platform 200 may execute their own OS. Additionally, or alternatively, one or more of the devices of heterogenous computing platform 200 may be virtual devices.

In the embodiment illustrated in FIG. 2, heterogenous computing platform 200 includes CPU clusters 201A-N that may correspond to system processor(s) 101, and that are intended to perform general-purpose computing operations. Each of CPU clusters 201A-N may include one or more processing cores and cache memories. In operation, CPU clusters 201A-N are available and accessible to the IHS's host OS 312 (e.g., WINDOWS on ARM) and other applications executed by IHS 100.

CPU clusters 201A-N may be coupled to memory controller 202 via internal interconnect fabric 203. Memory controller 202 may be responsible for managing system memory access for all of devices connected to internal interconnect fabric 203, which may include any communication bus suitable for inter-device communications within an SoC (e.g., Advanced Microcontroller Bus Architecture or “AMBA,” QuickPath Interconnect or “QPI,” HyperTransport or “HT,” etc.).

Devices coupled to internal interconnect fabric 203 may communicate with each other and with a host OS executed by CPU clusters 201A-N. In some cases, devices 209-211 may be coupled to internal interconnect fabric 203 via a secondary interconnect fabric (not shown). A secondary interconnect fabric may include any bus suitable for inter-device and/or inter-bus communications within an SoC.

GPU 204 produces graphical or visual content and communicates that content to a monitor or display of IHS 100 for rendering. In some embodiments, display engine or controller 209 may be designed to perform additional video enhancement operations. In operation, display engine 209 may implement procedures for providing the output of GPU 204 as a video signal to one or more external displays coupled to IHS 100 (e.g., display device(s) 111). PCIe interfaces 205 provide an entry point into any additional devices external to heterogenous computing platform 200 that have a respective PCIe interface (e.g., graphics cards, USB controllers, etc.).

Audio Digital Signal Processor (aDSP) 206 is a device designed to perform audio and speech operations and to perform in-line enhancements for audio input(s) and output(s). Examples of audio and speech operations include, but are not limited to: noise reduction, echo cancellation, directional audio detection, wake word detection, muting and volume controls, filters and effects, etc. In operation, input and/or output audio streams may pass through and be processed by aDSP 206, which can send the processed audio to other devices on internal interconnect fabric 203 (e.g., CPU clusters 201A-N).

In some embodiments, aDSP 206 may be configured to process one or more of heterogenous computing platform 200's sensor signals (e.g., gyroscope, accelerometer, pressure, temperature, etc.), low-power vision or camera streams (e.g., for user presence detection, onlooker detection, etc.), or battery data (e.g., to calculate a charge or discharge rate, current charge level, etc.).

Camera device 210 includes an Image Signal Processor (ISP) configured to receive and process video frames captured by a camera coupled to heterogenous computing platform 200 (e.g., in the visible and/or infrared spectrum). Video Processing Unit (VPU) 211 is a device designed to perform hardware video encoding and decoding operations, thus accelerating the operation of camera 210 and display/graphics device 209. VPU 211 may be configured to provide optimized communications with camera device 210 for performance improvements.

Sensor hub 207 may include AI capabilities designed to consolidate information received from other devices in heterogenous computing platform 200, process context and/or telemetry data streams, and provide that information to: (i) a host OS, (ii) other applications, and/or (iii) other devices in platform 200. In collecting data, sensor hub 207 may include General-Purpose Input/Output (GPIOs) that provide Inter-Integrated Circuit (I²C), Improved I²C (I³C), Serial Peripheral Interface (SPI), Enhanced SPI (eSPI), and/or serial interfaces to receive data from sensors (e.g., sensors 110, camera 210, peripherals 214, etc.). Sensor hub 207 may include a low-power core configured to execute small neural networks and specific applications, such as contextual awareness and other enhancements.

High-performance AI device 208 is a significantly more powerful processing device than sensor hub 207, and it may be designed to execute multiple complex AI algorithms and models concurrently (e.g., Natural Language Processing, speech recognition, speech-to-text transcription, video processing, gesture recognition, user engagement determinations, etc.). For example, high-performance AI device 208 may include a Neural Processing Unit (NPU), Tensor Processing Unit (TPU), Neural Network Processor (NNP), or Intelligence Processing Unit (IPU), and it may be designed specifically for AI and Machine Learning (ML), which speeds up the processing of AI/ML tasks while also freeing processor(s) 101 to perform other tasks. Using such capabilities, one or more devices of heterogenous computing platform 200 (e.g., GPU 204, aDSP 206, sensor hub 207, high-performance AI device 208, VPU 211, etc.) may be configured to execute one or more AI model(s), simulation(s), and/or inference(s).

Security device 212 may include one or more specialized security components, such as a dedicated security processor, a Trusted Platform Module (TPM), a TRUSTZONE device, a PLUTON processor, or the like. In various implementations, security device 212 may be used to perform cryptography operations (e.g., generation of key pairs, validation of digital certificates, etc.) and/or it may serve as a hardware RoT for heterogenous computing platform 200 and/or IHS 100.

Modem/wireless controller 213 may be designed to enable wired and wireless communications in any suitable frequency band (e.g., BLUETOOTH or “BT,” WiFi, CDMA, 5G, satellite, etc.), subject to AI-powered optimizations/customizations for improved speeds, reliability, and/or coverage.

Peripherals 214 may include any device coupled to heterogenous computing platform 200 (e.g., sensors 110) through mechanisms other than PCIe interfaces 205. In some cases, peripherals 214 may include interfaces to integrated devices (e.g., built-in microphones, speakers, and/or cameras), wired devices (e.g., external microphones, speakers, and/or cameras, Head-Mounted Devices/Displays or “HMDs,” printers, displays, etc.), and/or wireless devices (e.g., wireless audio headsets, etc.) coupled to IHS 100.

In some implementations, EC 109 may be integrated into heterogenous computing platform 200 of IHS 100. In other implementations EC 109 may be external to the heterogenous computing platform 200 (i.e., the EC 109 residing in its own semiconductor package) but coupled to integrated bridge 216 via an interface (e.g., enhanced SPI or “eSPI”), thus supporting the EC's ability to access the SoC's interconnect fabric 203, including sensor hub 207 and sensor(s) 110. Through this connectivity supported by interconnect fabric 203, EC 109 may directly access and/or operate most or all of devices 201-216, 110 of heterogenous computing platform 200.

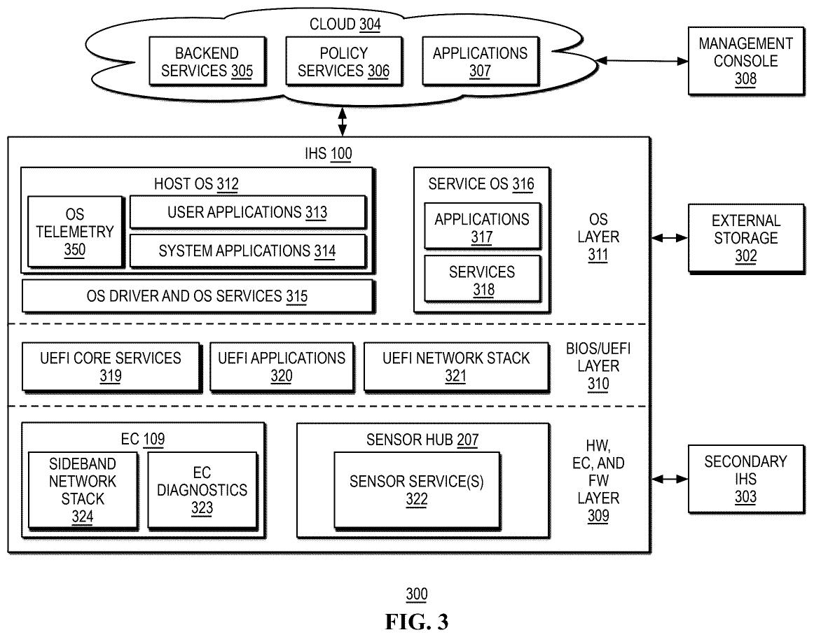

FIG. 3 is a diagram illustrating an example of architecture 300 usable with IHS 100. Particularly, architecture 300 includes IHS 100 (e.g., implementing aspects of IHS 100 and/or platform 200) coupled to storage device 302 (e.g., NVMe, SSD, etc.), secondary or companion IHS 303 (e.g., a smart phone, a laptop, etc.), and cloud or remote services 304. Cloud 304 may include backend or remote services 305, policy services 306, and web applications 307. In some cases, components of cloud 304 may be accessible to IHS 100 and/or secondary IHS 303, and configurable via ITDM management console 308.

IHS 100 may include hardware/EC/firmware layer 309, BIOS/UEFI layer 310, and OS layer 311. Specifically, OS layer 311 includes host OS 312 executed by host processor(s) 101. A variety of software applications may operate within OS 312, where these applications may include user applications 313 and system applications 314, including one or more applications configured to execute an LLM, or the like. Applications that operate within the OS 312 may also include one or more telemetry applications 350.

OS layer 311 may also include various drivers and other core OS operations, such as the operation of a kernel. As described, various components of heterogenous computing platform 200 may independently run their own OS, such as a Real-Time OS (RTOS) run by an SoC.

Within IHS 100, RTOSs executed by individual components of the heterogenous computing platform 200 are deemed distinct from service OS 316, which includes its own applications 317 and services 318. Hardware device drivers 315 used by host OS 312 and/or by service OSs 316 may support the operation of IHS 100 hardware.

BIOS/UEFI layer 310 may include pre-OS core services 319, pre-OS applications 320, and pre-OS network stack 321 that are each executed by BIOS/UEFI 107. BIOS core services 319 may include operations for identifying and validating the detected hardware components of IHS 100. BIOS applications 320 may include operations for interfacing with certain hardware devices of IHS 100, in particular user input devices. The network stack 321 of BIOS 310 may be utilized during initialization of IHS 100 in support of validation procedures, such as in retrieving reference signatures corresponding to authentic firmware instructions for hardware components of IHS 100.

As illustrated, IHS 100 also includes hardware/EC/firmware layer 309 with EC 109 and sensor hub 207. As described above, EC 109 may implement a variety of procedures for management of individual hardware of IHS 100. EC 109 is configured to execute one or more sensor services 323 that interface with sensor hub 207 in implementing various operations, such response to user-presence determination by the sensor hub 207 that is acted upon by the EC 109 in initiation heightened security protocols. Moreover, EC 109 may interface with some or all individual hardware components/systems of IHS 100 via sideband management channels that are separate from inline communication channels used by host processor(s) 101 and SoCs.

As previously described, sensor hub 207 may receive inputs from some or all sensors 110A-N of an IHS 100. Sensor hub 207 may implement a variety of sensor service(s) 322 for communicating with and collecting data from sensors 110A-N. In some embodiments, sensor hub 207 may implement shock detection procedures that may incorporate inputs from inertial and other sensors 110A-N of IHS 100. Shock detection procedures may detect shocks experienced by IHS 100 and may characterize and assess possible damage to IHS 100.

In various embodiments, systems and methods described herein introduce RBAC mechanisms specifically designed for LLM embeddings, for example, when host OS 312 executes LLM 600 as part of user applications 313 and/or system applications 314. As such, these systems and methods address the limitations of conventional RBAC systems, which are not equipped to handle the unstructured and vectorized nature of data in LLM embeddings.

In some implementations, these systems and methods may prioritize role context during the vectorization process, ensuring that the generated embeddings are cognizant of user roles. This allows for the creation of embeddings that inherently respect access control policies.

By integrating role tokens with document vectors through attention layers, these systems and methods may enable precise control over data access. This ensures that only authorized users can retrieve relevant information, enhancing data security and compliance with organizational data governance policies.

An Extract Transform to Document Load (ETDL) method is also provided for generating unstructured natural language documents from structured data. The ETDL method may create modular documents based on accessing entities, context, and roles, facilitating more granular control over data access.

Moreover, the use of attention layers to integrate role context into document vectors may allow for the efficient and secure retrieval of information. Pre and/or post attention layers may ensure that documents are only accessible to users with the appropriate roles, thereby preventing unauthorized access to sensitive information.

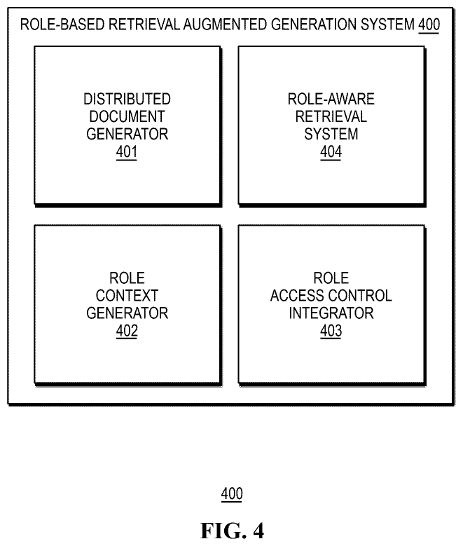

To illustrate this, FIG. 4 is a diagram illustrating an example of Role-Based Retrieval Augmented Generation (RBRAG) system 400 for RBAC using LLMs embeddings. In various embodiments, components of system 400 may be instantiated through execution of program instructions by processor 101 of IHS 100. Moreover, system 400 may be configured to perform one or more of the operations of method 500 in connection with the operation of an LLM by IHS 100, for example, in the context of an enterprise environment.

In this implementation, system 400 comprises Distributed Document Generator 401, Role Context Generator 402, Role Access Control Integrator 403, and Role-Aware Retrieval System 404.

Distributed Document Generator 401 may be configured to generate a plurality of distinct unstructured natural language documents from a portion of structured data of an enterprise. Structured data refers to data that is organized in a predefined manner, typically in tabular formats such as databases or spreadsheets, where each data item is stored in a specific field. Examples of structured data include customer records, transaction logs, and inventory lists.

Each document may be created for a corresponding role in the enterprise, ensuring that the generated documents are tailored to the specific access requirements of different roles. For example, a financial report may be generated for the finance team, a technical specification document for the IT team, and a summary report for executives. This role-based document generation ensures that each user receives information relevant to their responsibilities and access privileges.

Role Context Generator 402 may be configured to create role-specific tokens based on role data retrieved from an Identity and Access Management (IAM) database, or the like. These tokens may then be assembled into a role context vector that defines an access privilege for a document, ensuring that the generated embeddings are cognizant of user roles.

Role Access Control Integrator 403 may be configured to integrate the role context vector with the document vector associated with the document to produce a role-integrated document vector. This may allow for control over data access, ensuring that only authorized users can retrieve relevant information.

Role-Aware Retrieval System 404 may be configured to retrieve documents based on a similarity search. A “similarity search” is a technique used to find items in a dataset that are like a given query item. It may involve comparing vectorized representations of text to identify and retrieve contextually or semantically similar text. For example, if a user searches for “customer billing details,” the system uses may execute a similarity search to find documents with related content, such as invoices and payment records, by comparing their vector representations.

In this case, such a similarity search compares a vectorized query received from a user with the role-integrated document vectors. This ensures that the retrieval process respects the access control policies defined by the role context vectors, enhancing data security and compliance with organizational data governance policies.

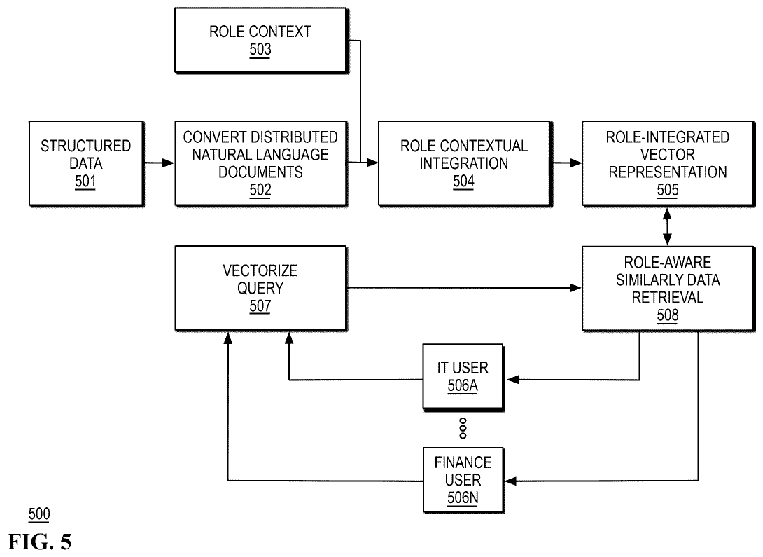

FIG. 5 is a diagram illustrating an example of method 500 for RBAC using LLMs embeddings. In various embodiments, operations of method 500 may be performed, at least in part, by components of system 500.

Particularly, method 500 starts with structured data 501, which may generally store data organized in a predefined manner, typically in tabular formats such as databases or spreadsheets. Examples of structured data include customer records, transaction logs, manufacturing documents, and inventory lists. In some cases, structured data 501 may provide an initial data input for method 500 and serve as a foundation for generating unstructured natural language documents, ensuring that the data is systematically organized and easily accessible for further processing.

At 502, method 500 converts structured data 501 into distributed natural language documents. For example, method 500 may generate a plurality of distinct unstructured natural language documents from the structured data. Each document may be created for a corresponding role in the enterprise, ensuring that the generated documents are tailored to the specific access requirements of different roles. The process involves transforming structured data into natural language documents that are more comprehensible to users and suitable for embedding in LLMs.

In some cases, at 502, Distributed Document Generator 401 may implement a process that transforms structured data into unstructured natural language documents, making the information more accessible and easier to interpret for LLMs and RAG systems. LLMs are trained to understand natural language rather than structured data with abstract column names (e.g., Cust_ID for Customer Number). In some cases, documents for embeddings may be created manually from available knowledge. In other cases, DDG may automatically generate modular documents based on accessing entity, context, and role, rather than creating a single document for customer transactions.

In DDG, a “Differentiating Entity” may represent the high-level tenant boundary for data segregation. For example, in order or subscription data, one customer should not see another customer's data. In that case, the customer is the tenant boundary, and the Differentiating Entity.

A “Context Entity” may represent what the user will be asking for at the highest level, such as “Order” and “Subscription” in an OEM context. These may be further divided into Sub-Context Entities as needed. For instance, an IT user can view Order/Subscription Details but not Order/Subscription Billing. Under “Order/Subscription” entities, “Details” and “Billing” are examples of Sub-Contexts.

In some implementations, the process of document generation from structured data like OLTP and OLAP systems for RBRAG may employ an Extract Transform to Document Load (ETDL), process, distinct from conventional Extract, Transform, Load (ETL) processes.

Particularly, ETDL may include configuring the Differentiating Entity in the dataset, tagging structured columns based on context and sub-context as per access requirements, and configuring prefixes and suffixes to generate base natural language from column data using a template-based approach. This process generates different documents for each context/sub-context.

For example, consider a first data structure in OLTP for Subscription Detail, and a second for Subscription Billing:

TABLE I
Subscription Detail

| SUBID | SUBSTART | SUBEND | Value | Prod_Desc | LOB | AgreementID | Cust_Name | Cust_ID | Bill | Contract |
|---|---|---|---|---|---|---|---|---|---|---|
| 767688748 | 2020 Oct. 23 | 2019 Oct. 26 | $5M | OEM Data | Protect | 2009539938802 | XYZCorp | 123545 | 1388893 | Years |

TABLE II
Subscription Billing

| SUBID | Year | Month | Amount | Generated | Paid | Invoice | Payment | Remaining | Bill Paid |
|---|---|---|---|---|---|---|---|---|---|
| 767688748 | 2023 | Nov | 138889 | Jan. 11, 2023 | Y | INV0001 | Credit | 4861111 | May 11, 2023 |
| 767688748 | 2023 | Dec | 138889 | Jan. 12, 2023 | Y | INV0002 | Credit | 4722222 | Jun. 12, 2023 |
| 767688748 | 2024 | Jan | 138889 | Jan. 12, 2023 | N | INV0002 | | | |

Distributed Document Generator 401 may use ETDL to transform this structured data into natural language documents. For example, it may read the dataset with structured columns, group the data by Differentiating Entity (e.g., Cust_ID), and further group by context/sub-context. It may then write the data using configured prefixes and suffixes to generate natural language documents.

To do this, Distributed Document Generator 401 may configure a Subscription Detail data structure based upon Tables I and II:

TABLE III
Subscription Billing

| | | | | | Role that has | Linker_{—} |
|---|---|---|---|---|---|---|
| Column | Context | SubContext | Prefix | Suffix | access to | Order |
| Cust_ID | | DIFF_ENTITY | with Customer | placed. | | 2 |
| | | | ID | | | |
| SUBSTART | DIFF_ENTITY | SUB_DETAILS | Subscription | and | IT_USER | 7 |
| | | | Start Date is | | | |
| SUBEND | DIFF_ENTITY | SUB_DETAILS | Subscription | Full stop | FIN_USER | 8 |
| | | | End Date is | | | |
| Total Value | DIFF_ENTITY | SUB_FIN | Total Value of | FullStop | LIC_MANAGER | 9 |
| | | | Subscription is | | | |
| Prod_Desc | DIFF_ENTITY | SUB_DETAILS | Product | and | | 5 |
| | | | description is | | | |
| LOB | DIFF_ENTITY | SUB_DETAILS | belongs to | Line Of | | 6 |
| | | | | Business. | | |
| AgreementID | DIFF_ENTITY | SUB_DETAILS, | Subscription | and | | 3 |
| | | SUB_FIN | with agreement | | | |
| | | | ID | | | |
| Cust_Name | DIFF_ENTITY | SUB_DETAILS, | Customer | | | 1 |
| | | SUB_FIN | named | | | |
| SUB_ID | DIFF_ENTITY | SUB_DETAILS, | Subscription ID | Fullstop. | | 4 |
| | | SUB_FIN | | | | |
| Monthly_Bill | DIFF_ENTITY | SUB_FIN | Expected | | | 11 |
| | | | Monthly Bill is | | | |
| Contract | DIFF_ENTITY | SUB_FIN | Subscription | and | | 10 |
| | | | Contract is | | | |

Then, Distributed Document Generator 401 may extract data from the dataset and, using a Natural Language Linkers Configuration process, transform the dataset into the first level of natural language based on the configured prefixes and suffixes.

In some implementations, the logic of the first conversion may be as illustrated by the following operations 1-14:
1. Read the dataset with structured columns and keep it in memory.
2. Read the configurator with linkers configuration, ordered by Linker_Order.
3. Get the column of the “Differentiating Entity” (e.g., Cust_ID).
4. Group the original dataset by the Differentiating Entity column.
5. Get the first group of the dataset.
6. Group by context/sub-context.
7. Get the next data from the first group.
8. Read the data in the linkers configuration.
9. Write the prefix followed by a space.
10. Write the data.
11. Write the suffix.
12. Get the next data.
13. Repeat operations 7-12 while data in the group is not null, creating one document for each differentiating entity and context/sub-context.
14. Return to 4 and repeat the process for the next group.

For example, for Cust_ID=‘XYZ Corp,’ execution of operations 1-14 may result in two documents: one for Sub-Context SUB_DETAILS and another for Sub-Context SUB_FIN.

For purposes of illustration, consider the document generated for SUB_DETAILS may read: “Customer XYZ Corp, with Customer ID 123545 placed subscription with Agreement ID 2009539938802 and Subscription ID 767688748. Product description is OEM Data Domain belongs to Data Protect Line of business.” This document contains only high-level details of the subscription without financial information.

Meanwhile, the document generated for SUB_FIN may read: “Customer XYZ Corp, with Customer ID 123545 placed subscription with Agreement ID 2009539938802 and Subscription ID 767688748. Subscription Start Date is 20/10/2023 and Subscription End date is 19/10/2026. Total Value of the Subscription is 5 Million. The Contract of the Subscription is for 3 Years and Expected Monthly Billing is 13888.” This document includes financial information. Both documents fall under the broader category of Differentiating Entity (Cust_ID->Customer).

Back to FIG. 3, at 503, Role Context Generator 402 may create role-specific tokens based on role data retrieved from an Identity and Access Management (IAM) database or other source. These tokens may be assembled into a role context vector that defines an access privilege for a document.

For example, Role Context Generator 402 may manage authentication (AuthN) and authorization (AuthZ) roles in an IAM system for a given application. In the example above, the IAM system may define the roles IT_OPS and FIN_OPS for the XYZ application, which has the customer as the user.

For each customer, the system may create two contextual documents such as, for example:
“IT_OPS_Role_Context (Role Token):
Role: IT_OPS
Customer ID: 123545”

This document is accessible only to users who hold the Customer ID ‘123545’ and the role IT_OPS.
“FIN_OPS_Role_Context (Role Token):
Role: FIN_OPS
Customer ID: 123545”

This document is accessible only to users who hold the Customer ID ‘123545’ and the role FIN_OPS.

In various embodiments, each token may be adjusted according to the LLM and similarity search that is used.

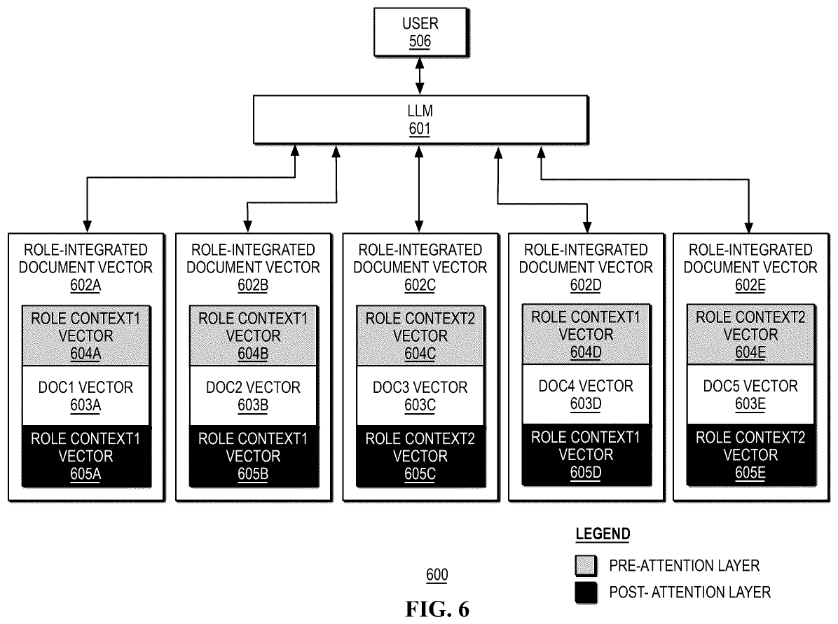

At 504, Role Access Control Integrator 403 may integrate the role context vector with the document vector associated with the document to produce a role-integrated document vector, stored in role-integrated document database 505. This integration may provide control over data access, ensuring that only authorized users can retrieve relevant information. This process may include combining the role context with the document vector, creating a composite vector that encapsulates both the document content and the access control information, for example, as shown in FIG. 6.

Users 506A-N (e.g., IT User 506A and Finance User 506N) may have different roles or jobs within the enterprise. These users may interact with IHS 100 to retrieve documents relevant to their roles. System 400 ensures that each user receives information pertinent to their responsibilities and access privileges, at least in part, by implementing method 500. These components illustrate the practical application of the role-based access control system, demonstrating how different users with distinct roles can access tailored information securely and efficiently.

Particularly, when any given user 506 enters a prompt or query into an LLM, the LLM may vectorize the query at 507 prior to performing a role-aware similarly data search and retrieval operation 508 with respect to the role-integrated document vectors.

Role-aware similarly data search 508 may retrieve documents based on a similarity search. This search compares a vectorized query received from a user with the role-integrated document vectors 505. The retrieval process may follow the access control policies defined by the role context vectors, enhancing data security and compliance with organizational data governance policies. As such, role-aware similarly data search 508 may provide search results filtered based on the user's role, containing only the information that the user is authorized to access.

FIG. 6 shows diagram 600 illustrating examples of role-integrated document vectors 602A-E being analyzed during role-aware similarly data search operation 508 of method 500. In various embodiments, role-integrated document vectors 602A-E may be used to retrieve corresponding documents during LLM search operation 508.

In this case, diagram 600 shows enterprise user 506, LLM 601, and a plurality of role-integrated document vectors 602A-E. User 506 may be associated with a specific role context, which may define their access privileges.

In operation, LLM 601 may be configured to load and compare the user's vectorized query with document vectors 603A-E of role-integrated document vectors 602A-E to retrieve relevant documents. LLM 601 may ensure, though the use of pre-attention and post-attention layers that the retrieval process respects the access control policies defined by the role context of the user 506.

Document vectors 603A-E each represent a vectorized form of a respective document. A shown, each document vector 603A-E may be integrated with corresponding a pre-attention role context vector 604A-E and/or a post-attention role context vector 605A-E that define the access privileges for the associated document.

This integration ensures that only authorized users with the appropriate roles can retrieve the document represented by any given one of role-integrated document vectors 602A-E. In this manner, system 400 ensures that each user 506 receives information pertinent to their responsibilities and access privileges by implementing role-based access control mechanisms.

During content retrieval a prompt may be created with selected information representative of the user's context. In the example above, the relevant parts may be the “Customer ID” and the role of the logged-in user. The process may begin when a user logs into an application. The application retrieves the claims of the user, such as Customer ID and role. These relevant parts are then vectorized for retrieval, forming a context vector. The user query may be encoded along with the context vector.

Within LLM 601, the search process may involve many operations. First, the search may apply attention layers. Attention layers are mechanisms usable by LLM 601 to focus on specific parts of the input data that are most relevant to the task at hand. These layers help the model to weigh the importance of different parts of the input, allowing it to prioritize certain information over others. Attention layers may be divided into pre-attention and post-attention layers, each serving a distinct purpose in the data processing pipeline.

Pre-attention layers may be applied before the main processing of the input data. They help to filter out irrelevant information early in the process, ensuring that only the most pertinent data is considered during the subsequent stages. In various embodiments, one or more pre-attention layers may be used to exclude documents from a search if the user's role does not match the role specified in the role-integrated document vector. This early filtering helps to reduce the computational load and improve the efficiency of the search process.

Post-attention layers, on the other hand, may be applied after the main processing of the input data. They help to refine the results by further analyzing the context and relevance of the information. In various embodiments, one or more post-attention layers may be be used to determine whether a user's context matches the context specified in the role-integrated document vector. This additional layer of filtering ensures that the retrieved documents are not only relevant to the user's query but also comply with the access control policies defined by the role context.

If the pre-attention is not resolved, the document may receive a lower rating and be skipped (e.g., role-integrated document vectors 602C and 602E). The search may proceed in a top-down or bottom-up manner. If the relevant parts are not available at the bottom layer (post-attention integration), the document may be skipped. Finally, the LLM (or a similar search mechanism) retrieves the most relevant document(s) (e.g., role-integrated document vectors 602A, 602B, and 602D) for the role that the user holds.

In our example, user “Shibi” from XYZ Corp may log into an LLM enabled application 313. An IAM system provides the Company ID=123545 and the role “IT_OPS.” Another user, “Joe,” logs into the same application with the same Company ID but with the role “FIN_OPS.”

Both users ask the query, “Please let me know the billing amount of last month for subscription 123232.” Shibi, with the IT_OPS role, may not receive a response, as the application may provide a response indicating that the user does not have the privilege to access billing information. Joe, with the FIN_OPS role, may receive the response with the billing amount information, as he has the appropriate access privileges.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes may be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein regarding specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution, cause the IHS to:
generate a plurality of distinct unstructured natural language documents from a same portion of structured data of an enterprise, wherein each document is created for a corresponding role in the enterprise; and
concatenate a role context vector that defines an access privilege for a document with a document vector associated with the document to produce a role-integrated document vector.

2. The IHS of claim 1, wherein to generate the plurality of distinct unstructured natural language documents, the program instructions, upon execution, further cause the IHS to:
select a differentiating entity;
add selected ones of a plurality of data items to different Natural Language templates based, at least in part, upon the differentiating entity.

3. The IHS of claim 2, wherein the differentiating entity comprises a customer identifier.

4. The IHS of claim 2, wherein to generate the plurality of distinct unstructured natural language documents, the program instructions, upon execution, further cause the IHS to:
associate each of plurality of data items with a respective context indicator; and
add the selected ones of plurality of data items to the different Natural Language templates based, at least in part, upon the context indicators.

5. The IHS of claim 4, wherein the context indicators comprise at least one of: human resources, financial information, Information Technology (IT), customer service, sales data, marketing analytics, product details, legal documents, compliance records, supply chain information, project management data, research and development reports, inventory levels, procurement details, or executive summaries.

6. The IHS of claim 1, wherein to produce the role-integrated document vector, the program instructions, upon execution, further cause the IHS to:
create role-specific tokens based, at least in part, upon role data retrieved from an Identity and Access Management (IAM) database; and
assemble the role-specific tokens into the role context vector.

7. The IHS of claim 6, wherein the program instructions, upon execution, further cause the IHS to apply a pre-attention layer's attention to the role context vector, and wherein the pre-attention layer is configured to exclude the document from a Large Language Model (LLM) search if a user's role does not match a role specified in the role-integrated document vector.

8. The IHS of claim 6, wherein the program instructions, upon execution, further cause the IHS to apply a post-attention layer's attention to the role context vector, and wherein the post-attention layer is configured to determine whether a user's context matches a context specified in the role-integrated document vector.

9. The IHS of claim 1, wherein the program instructions, upon execution, further cause the IHS to:
vectorize a query received by a Large Language Model (LLM) from a user; and
retrieve one or more of the documents as part of a similarity search to fulfill the query based, at least in part, upon a comparison between the vectorized query and the role-integrated document vectors for each of the one or more documents.

10. A method, comprising:
generating a plurality of distinct unstructured natural language documents from a same portion of structured data of an enterprise, wherein each document is created for a corresponding role in the enterprise, and wherein document is associated with one or more context indicators; and
integrating a role context vector that defines an access privilege for a document with a document vector associated with the document to produce a role-integrated document vector.

11. The method of claim 10, wherein generating the plurality of distinct unstructured natural language documents further comprises:
selecting a differentiating entity; and
adding selected ones of a plurality of data items to different Natural Language templates based, at least in part, upon the differentiating entity.

12. The method of claim 11, wherein the differentiating entity comprises a customer identifier.

13. The method of claim 10, wherein the one or more context indicators comprise at least one of: human resources, financial information, Information Technology (IT), customer service, sales data, marketing analytics, product details, legal documents, compliance records, supply chain information, project management data, research and development reports, inventory levels, procurement details, or executive summaries.

14. The method of claim 10, wherein producing the role-integrated document vector further comprises:
assembling role-specific tokens into the role context vector; and
concatenate the role context vector with the document vector.

15. The method of claim 10, further comprising:
vectorizing a query received by a Large Language Model (LLM) from a user; and
retrieving one or more of the documents as part of a similarity search to fulfill the query based, at least in part, upon a comparison between the vectorized query and the role-integrated document vectors for each of the one or more documents.

16. A hardware memory device having program instructions stored thereon that, upon execution by a processor of an Information Handling System (IHS), cause the IHS to:
generate a plurality of distinct unstructured natural language documents from a same portion of structured data of an enterprise, wherein each document is created for a corresponding role in the enterprise, and wherein document is associated with one or more context indicators; and
integrate a role context vector that defines an access privilege for a document with a document vector associated with the document to produce a role-integrated document vector.

17. The hardware memory device of claim 16, wherein to generate the plurality of distinct unstructured natural language documents, the program instructions, upon execution, further cause the IHS to:
associate each of plurality of data items with a respective context indicator; and
add the selected ones of plurality of data items to the different Natural Language templates based, at least in part, upon the context indicators.

18. The hardware memory device of claim 16, wherein to produce the role-integrated document vector, the program instructions, upon execution, further cause the IHS to:
apply a pre-attention layer's attention to the role context vector, wherein the pre-attention layer is configured to exclude the document from a Large Language Model (LLM) search if a user's role does not match a role specified in the role-integrated document vector; and
apply a post-attention layer's attention to the role context vector, wherein the post-attention layer is configured to determine whether a user's context matches a context specified in the role-integrated document vector.

19. The hardware memory device of claim 16, wherein the processor is part of a heterogenous computing platform selected from the group consisting of: a System-On-Chip (SoC), a Field-Programmable Gate Array (FPGA), and an Application-Specific Integrated Circuit (ASIC).

20. The hardware memory device of claim 19, wherein the heterogenous computing platform comprises a Reduced Instruction Set Computer (RISC) processor coupled to an Embedded Controller (EC) via an interconnect, and wherein the interconnect comprises at least one of: an Advanced Microcontroller Bus Architecture (AMBA) bus, a QuickPath Interconnect (QPI) bus, or a HyperTransport (HT) bus.
